(19) United States
(12) Patent Application Publication
(10) Pub. No.: US 2012/0222458 A1
(43) Pub. Date: Sep. 6, 2012

(54) PRINTER SECURITY SYSTEM

(76) Inventor: Meir Avganim, Gealya (IL)

(21) Appl. No.: 13/411,285

(22) Filed: Mar. 2, 2012

Related U.S. Application Data
(60) Provisional application No. 61/449,173, filed on Mar. 4, 2011.

(51) Int. Cl. E05B 73/00

(52) U.S. Cl. 70/58

(57) ABSTRACT

A security apparatus which secures a portable device such as a printer and has a substantially flat base which has openings to receive mushroom-head studs of the printer. An upright plate extends substantially perpendicular from the base and is positioned against the rear of the printer housing and its cover, to prevent opening of the cover. A locking shaft is movable to a locking position to prevent disconnecting the printer housing from the base of the security apparatus. The locking shaft is secured in its locking position by means of a locking mechanism which is operated by a key, which can be any type of key, including push button keys or a combination lock and the like.

### CROSS-REFERENCE TO RELATED APPLICATIONS

This application claims benefit of and priority to U.S. Provisional Application Ser. No. 61/449,173 filed Mar. 4, 2011, which is incorporated herein by reference in its entirety.

### BACKGROUND OF THE INVENTION

The present invention relates to a security system for certain printer models and, more particularly, to a security system for printers that have a base and a pivotally attached upper cover that covers the paper spool within the printer.

In certain printer models, the printer construction is of a type as shown in FIG. 1 herein. Thus, the printer 12 has the base which houses the interior mechanism and a portion of the paper feed mechanism, as well as an upper cover 12b which pivots around a pivoting axis 12c. In use, the printer cover 12b is pivoted open to exchange the paper roll. Certain business establishments have had the unpleasant experience that the spooled paper stock is removed to effect the theft thereof or for other undesired purposes. The aim of the present invention is to prevent such occurrence, while simultaneously locking the printer itself to a base surface, while at the same time, locking its cover.

### SUMMARY OF THE INVENTION

It is an object of the present invention to avoid the aforementioned drawbacks of the prior art.

Essentially, the system apparatus and device of the present invention attaches a base to the printer 12, as well as a locking device where the key operated locking device inter-engages with the plate, locking them together, while at the same time providing an upright and bent flange that bears against the rear wall of the cover of the printer, to prevent its opening.

Other features and advantages of the present invention will become apparent from the following description of the invention which refers to the accompanying drawings.

### BRIEF DESCRIPTION OF THE DRAWINGS

FIG. 1 a perspective of the invention showing the printer and the relative location of the security system.

FIG. 2 is a bottom view of FIG. 1.

FIG. 3 is an exploded view of FIG. 1.

FIG. 4 is a perspective of FIG. 1 in a see-through view.

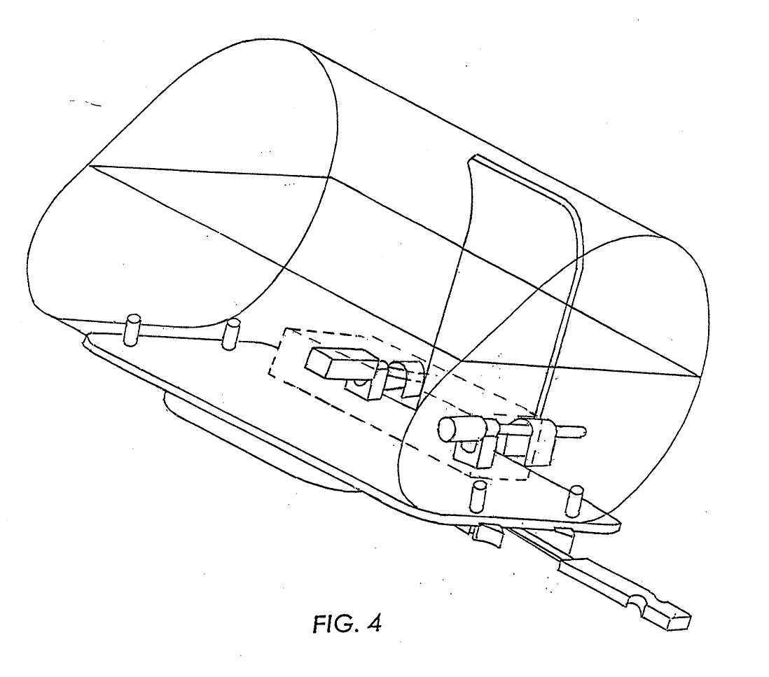

FIG. 5 is a rear view of FIG. 4.

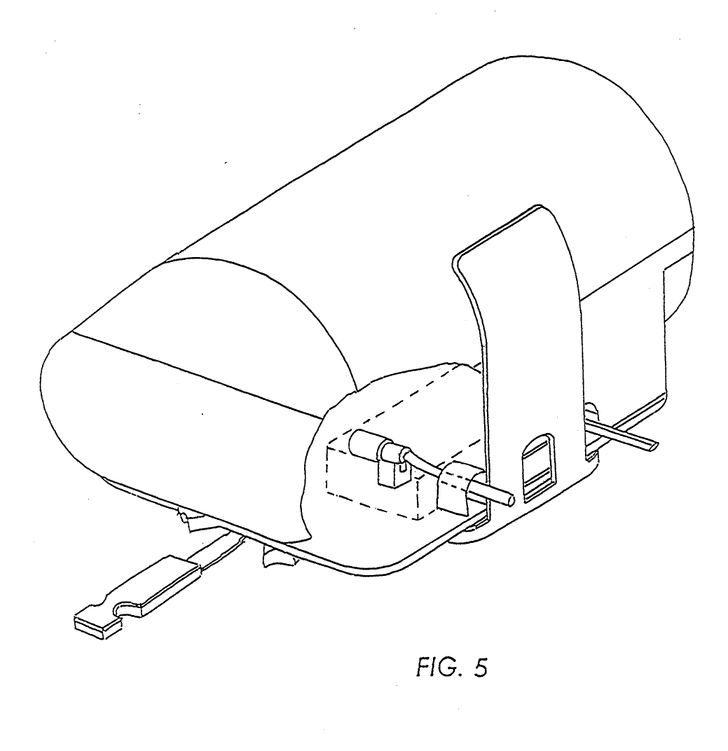

FIG. 6 is a bottom view of FIG. 1.

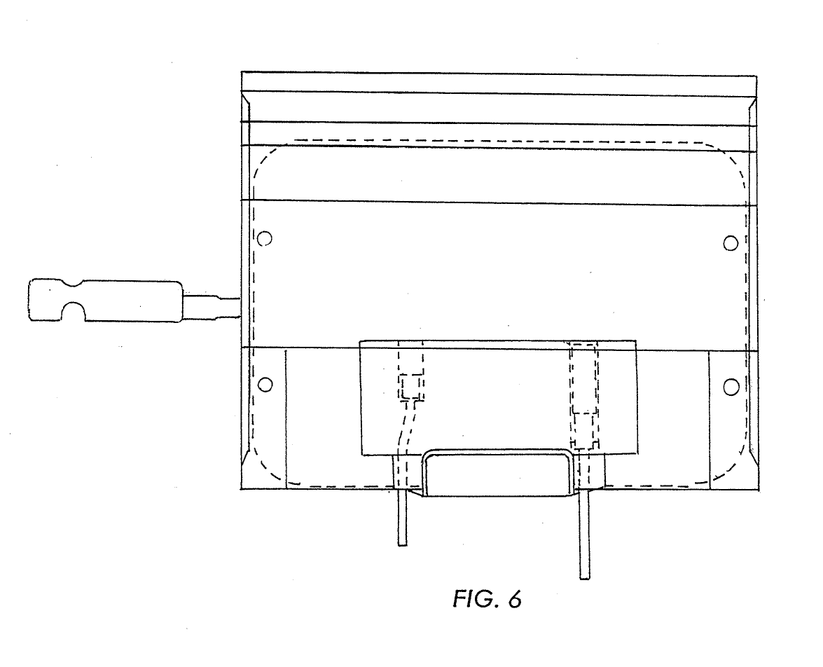

### DETAILED DESCRIPTION OF EMBODIMENTS OF THE INVENTION

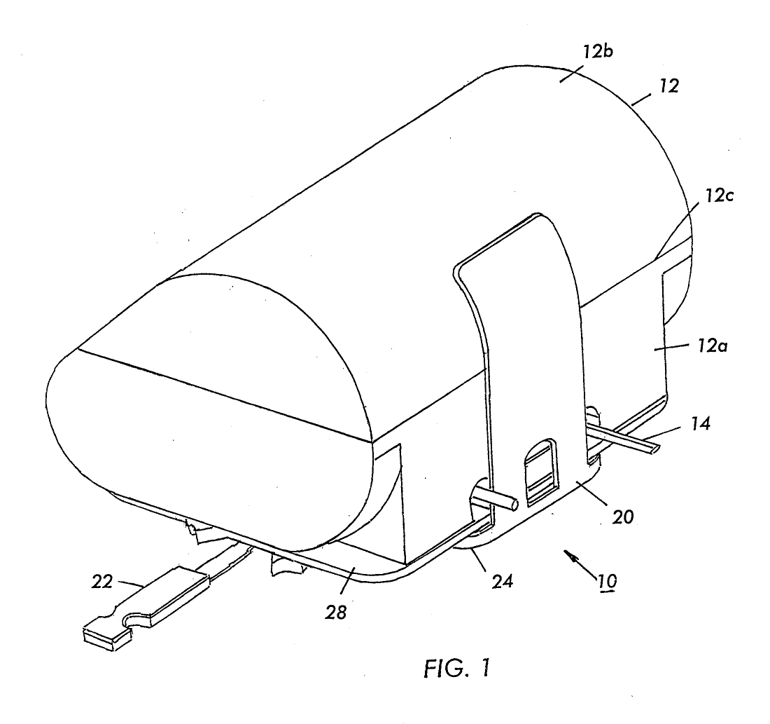

As shown in FIG. 1, the printer 12 is attachable to a security system 20 which comprises a base plate 28 which is attachable to a lock carrying protection device 24 and lockable therein via a key 22. The locking mechanism permits the cables 14 to extend without obstruction toward other devices, power outlets and the like.

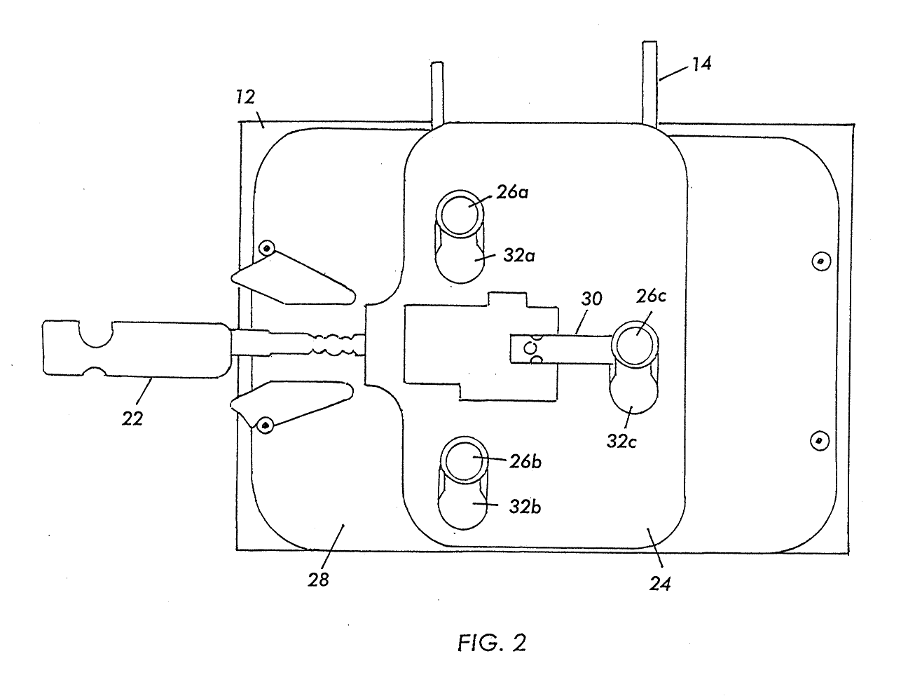

As shown in FIG. 2, the base plate 28 is attached to the bottom of the printer 12 by means of screws and the like, shown at the periphery of the base plate 28. The base plate has a plurality (these in FIG. 2) of mushroom-head studs 26a, 26b and 26c, which are received in corresponding openings 32a, 32b and 32c and allowed to slide within said openings to a narrowed section, at which point the shaft 30 of the locking mechanism is moved forward, grabbing the mushroom-head stud 26c and preventing removal or sliding of the plate 28 holding the printer 4 in a manner which would allow its removal. The locking shaft 30 can be opened and closed by a operating the flat key 22.

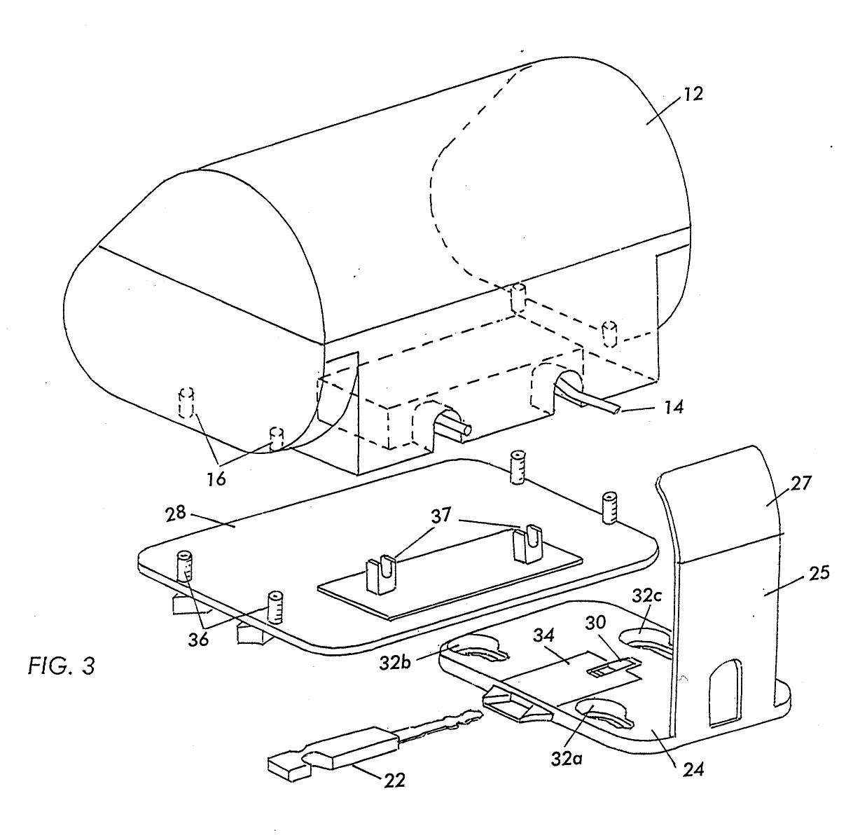

Additional details of FIG. 2 can be observed in the exploded view of FIG. 3. The printer 12 is shown hovering in the air and having cavities 16 on the left and right sides thereof. When the base plate 28, which has the upright studs 36 at the left and right side thereof, is brought up and inserted inside the socket 16 and attached to the printer with screws, it becomes a part thereof. The plate 28 also has cable holding brackets 37 which, when the plate 28 is pushed against the bottom of printer 12, grab the cable 14 and prevent the cables from being pulled out, as by pulling on the cable shown in FIG. 1.

The mushroom-head catches 26a, 26b and 26c are received within the larger diameter portion of the openings 32a, 32b and 32c of the protective device 24 and once inserted therein, can be slid toward the upright 25, being locked in the narrow section of the socket.

The locking cylinder is shown at 34, including its locking shaft 30 which moves laterally toward or away from the socket 32c. When the base plate 28 attached to the printer is slid to lock inside the protective device 24, and the key is operated, the locking shaft 30 engages at least one of the mushroom-heads and locks it in place.

At the same time, the curved portion 27 of the upright 25 bears against the rear of the printer cover 12b, preventing its opening.

The base plate can be secured to the underside of the printer by screws or adhesive.

As described above, the present invention is directed to a security apparatus for securing a portable object having a bottom plate with projecting locking elements, an object housing on the bottom plate and an cover pivotally connected to the object housing, the security apparatus comprising: a substantially flat base extending in a horizontal plane, the base having openings for receiving the projecting locking elements of the portable object; an upright plate extending substantially perpendicularly to the base from a peripheral edge of the base, in a configuration such that when the portable object is on the base, the upright plate blocks and prevents opening of said cover of said housing; a movable locking shaft movable between first and second positions, wherein in the first position said shaft engages at least one of said locking elements of said object and prevents the disengagement of said object from said base and in the second position permits this disengagement of said portable object; and a key operated locking mechanism for said shaft which is configured to lock said shaft in said first position.

In preferred embodiments, the portable object is a printer located within the housing and the cover is configured to enclose printing paper associated with a printer. The locking elements can be configured as mushroom-head studs which are receivable within the openings in the base. Still further, the locking mechanism, as clearly shown in the drawings, has a locking cylinder which is substantially flat and which is operated with a flat locking shaft and a flat key. Holding brackets may be provided which are configured to grab onto and hold at least one cable associated with the printer, to prevent the cable from being pulled out from the printer housing. The upright plate is curved, at least in part, to conform to the backside shape of the printer housing, including the cover. The base of the security apparatus can have openings through which bolts or screws can be passed in order to connect the base immovably to the underlying table surface of workbench and the like.

The key operated locking mechanism can be manually operated by any type of key whether it be an ordinary key, or a pushbutton type key, or even a combination lock operating in conjunction with a push cylinder.

Although the present invention has been described in relation to particular embodiments thereof, many other variations and modifications and other uses will become apparent to those skilled in the art. It is preferred, therefore, that the present invention be limited not by the specific disclosure herein, but only by the appended claims.

1. A security apparatus for securing a portable object having a bottom plate with projecting locking elements, an object housing on the bottom plate and a cover pivotally connected to the object housing, the security apparatus comprising:
a substantially flat base extending in a horizontal plane, the base having openings for receiving the projecting locking elements of the portable object;
an upright plate extending substantially perpendicularly to the base from a peripheral edge of the base, in a configuration such that when the portable object is on the base, the upright plate blocks and prevents opening of said cover of said housing;
a movable locking shaft movable between first and second positions, wherein in the first position said shaft engages at least one of said locking elements of said object and prevents the disengagement of said object from said base and in the second position permits this disengagement of said portable object; and
a locking mechanism for said shaft which is configured to lock said shaft in said first position.

2. The security apparatus of claim 1, wherein said portable object is a printer located within said housing and said cover is configured to enclose printing paper associated with said printer.

3. The security apparatus of claim 2, wherein said locking elements are configured as mushroom-head studs which are receivable within said openings in said base.

4. The security apparatus of claim 1, wherein said locking mechanism comprises a locking cylinder which operates said locking shaft.

5. The security apparatus of claim 4, wherein said locking cylinder and said key have a flat construction and shape.

6. The security apparatus of claim 2, further including holding brackets configured to grab onto and hold at least one cable associated with said printer to prevent said cable from being pulled out from said object housing.

7. The security apparatus of claim 1, wherein said upright plate has at least a portion thereof which is curved to the shape of said object housing and/or cover.

8. The security apparatus of claim 1, further comprising screw openings located in the base and providing openings for attaching screws for passing fastening means by which the base is secured to a table surface on which the base is located.

9. The security apparatus of claim 1, including a key for said locking mechanism.
